(19) United States
(12) Patent Application Publication
(10) Pub. No.: US 2013/0286098 A1
(43) Pub. Date: Oct. 31, 2013

(54) LIQUID DISCHARGE HEAD AND METHOD OF MANUFACTURING THE SAME

(71) Applicant: CANON KABUSHIKI KAISHA, Tokyo (JP)

(72) Inventors: Kenji Yabe, Yokohama-shi (JP); Yasunori Takei, Tokyo (JP); Takuma Kodoi, Kawasaki-shi (JP); Ken Ikegame, Ebina-shi (JP); Isamu Horiuchi, Yokohama-shi (JP); Hyo Takahashi, Kunitachi-shi (JP)

(73) Assignee: CANON KABUSHIKI KAISHA, Tokyo (JP)

(21) Appl. No.: 13/864,684

(22) Filed: Apr. 17, 2013

(30) Foreign Application Priority Data
Apr. 27, 2012 (JP) 2012-103319

(51) Int. Cl. B41J 2/14; B41J 2/16

(52) U.S. Cl. CPC B41J 2/1433; B41J 2/1621
USPC 347/47; 29/890.1

(57) ABSTRACT

Provided is a liquid discharge head including: a discharge port that serves to discharge a liquid; a discharge energy generating element that generates energy used to discharge the liquid; a foam chamber that houses the discharge energy generating element and is communicated with the discharge port; and a flow channel that is communicated with the foam chamber and serves to supply the liquid to the foam chamber. An inclined surface is formed between: a side wall of the foam chamber on a side opposite to the flow channel; and a surface of the foam chamber on which the discharge port is formed, and the inclined surface is inclined to a plane on which the discharge energy generating element is formed.

### BACKGROUND OF THE INVENTION

1. Field of the Invention

The present invention relates to a liquid discharge head and a method of manufacturing the same.

2. Description of the Related Art

The factors that determine ink discharge characteristics of a thermal-type liquid discharge head that discharges a liquid such as ink includes discharge port, a discharge energy generating element, the positional relation between the discharge energy generating element and the discharge port, and the internal structure of a flow channel. In a liquid discharge head, a foam chamber is provided for each discharge port so as to surround the corresponding discharge energy generating element, and each foam chamber is communicated with a common liquid chamber through the flow channel. The dimensions of the foam chamber are determined according to the shape and area of the corresponding discharge energy generating element in many cases. If the foam chamber is excessively large or small, it is more difficult to obtain stable ink discharge performance.

In recent years, along with the demand for speed-up and higher image quality of an ink-jet printer, the horizontal-to-vertical ratio of each discharge energy generating element (and each foam chamber) tends to be increased in order to densely arrange the discharge ports (see U.S. Pat. No. 7,690,760). That is, if the dimensions of the discharge energy generating element are set so as to be short in the arrangement direction of the discharge ports (hereinafter, Y direction) and long in the direction (hereinafter, X direction) perpendicular to the Y direction, the discharge energy generating elements can be more densely placed even in the same area.

In this case, in the Y direction, if the interval between the discharge energy generating element and a wall of the foam chamber is made as small as possible, the interval between adjacent foam chambers can be increased. This is because, if the width of the foam chamber is increased and the interval between adjacent foam chambers is decreased, the joint area between a flow channel forming member that defines the foam chamber and a substrate provided with the discharge energy generating element is smaller. If the joint area is smaller, a trouble in the quality of the liquid discharge head is more likely to occur. For example, the flow channel forming member and the substrate may be separated from each other. Accordingly, in the Y direction, for the purpose of improving the reliability of the head, the wall of the foam chamber is kept as perpendicular to the substrate surface as possible, whereby the interval between adjacent foam chambers can be sufficiently secured.

Meanwhile, in the X direction, although the allowance of the dimensions is relatively large, the respective distances from the discharge port and the discharge energy generating element to the wall of the foam chamber are both long. Hence, a stagnation region with a small flow of ink is unfavorably generated in a far-side region of the foam chamber, that is, a region thereof opposite to the common liquid chamber. As a result, bubbles that are taken in from the discharge port at the time of ink discharge accumulate more easily in this region. This is highly likely to affect the thermal-type liquid discharge head that stably repeats foaming and defoaming. That is, foaming and defoaming on the discharge energy generating element may be prevented, and, at the time of the ink discharge, the accumulated bubbles and the discharged ink interfere with each other, so that normal ink droplet discharge may be prevented.

Japanese Patent Application Laid-Open No. 2008-238401 discloses a liquid discharge head having a configuration that suppresses air bubbles from accumulating in a foam chamber. In this liquid discharge head, the center of a discharge port is offset toward the far side of the foam chamber with respect to the center of a discharge energy generating element. Such a configuration can make the distance from the discharge port to the far-side wall of the foam chamber relatively short, whereby a stagnation portion can be reduced. As a result, bubbles that are taken in from the discharge port can be suppressed from accumulating in the foam chamber.

In such a liquid discharge head as disclosed in U.S. Pat. No. 7,690,760, which has a high-density discharge port arrangement of 1,200 dpi or more (in-line), in order to discharge ink droplets of, particularly, about 1 to 5 pl, it is necessary to further elongate the foam chamber and the discharge energy generating element. In order to apply the configuration disclosed in Japanese Patent Application Laid-Open No. 2008-238401 to such a liquid discharge head, it is necessary to make the amount of offset of the discharge port with respect to the discharge energy generating element extremely large. In this case, there occurs a significant difference between the foaming center of the discharge energy generating element and the center of the discharge port, and such a difference adversely affects droplet formation at the time of ink discharge. Hence, in order to achieve a high efficiency in ink discharge performance and an excellent precision of ink droplet landing on a sheet, the center of the discharge energy generating element and the center of the discharge port need to coincide with each other.

### SUMMARY OF THE INVENTION

The present invention provides a liquid discharge head including: a discharge port that serves to discharge a liquid; a discharge energy generating element that generates energy used to discharge the liquid; a foam chamber that houses the discharge energy generating element and is communicated with the discharge port; and a flow channel that is communicated with the foam chamber and serves to supply the liquid to the foam chamber. An inclined surface is formed between: a side wall of the foam chamber on a side opposite to the flow channel; and a surface of the foam chamber on which the discharge port is formed, and the inclined surface is inclined to a plane on which the discharge energy generating element is formed.

Further features of the present invention will become apparent from the following description of exemplary embodiments with reference to the attached drawings.

### BRIEF DESCRIPTION OF THE DRAWINGS

FIG. 1 is a perspective view illustrating an example of a liquid discharge head according to an embodiment of the present invention.

FIG. 2 is a plan view illustrating the liquid discharge head according to the present embodiment.

FIG. 3A is a schematic plan view illustrating the liquid discharge head according to the present embodiment.

FIG. 3B is a schematic sectional view illustrating the liquid discharge head according to the present embodiment.

FIGS. 4A, 4B, 4C, 4D, 4E, 4F and 4G are sectional views each illustrating a step of manufacturing the liquid discharge head according to the present embodiment.

FIG. 5 is an enlarged sectional view illustrating a configuration in the vicinity of a discharge port of a conventional liquid discharge head.

FIG. 6 is an enlarged sectional view illustrating a configuration in the vicinity of a discharge port according to the present embodiment.

FIG. 7 is a schematic view illustrating the liquid discharge head according to the present embodiment.

FIG. 8 is a schematic view illustrating the liquid discharge head according to the present embodiment.

FIG. 9 is a schematic view illustrating the liquid discharge head according to the present embodiment.

FIG. 10A is a plan view illustrating the liquid discharge head according to the present embodiment.

FIG. 10B is a schematic view illustrating the liquid discharge head according to the present embodiment.

### DESCRIPTION OF THE EMBODIMENTS

Preferred embodiments of the present invention will now be described in detail in accordance with the accompanying drawings.

Hereinafter, an embodiment of the present invention is described referring to the attached drawings. Note that the present invention is not limited to the following embodiment, and can be applied to other techniques that should be encompassed in the concepts of the invention described in WHAT IS CLAIMED IS of the present specification.

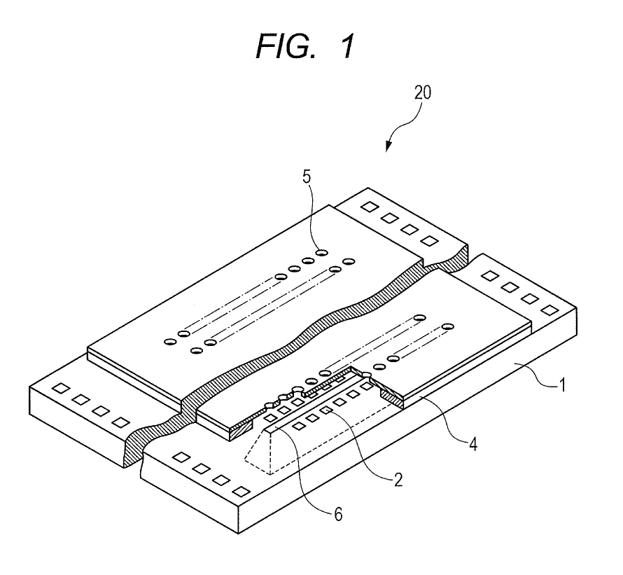

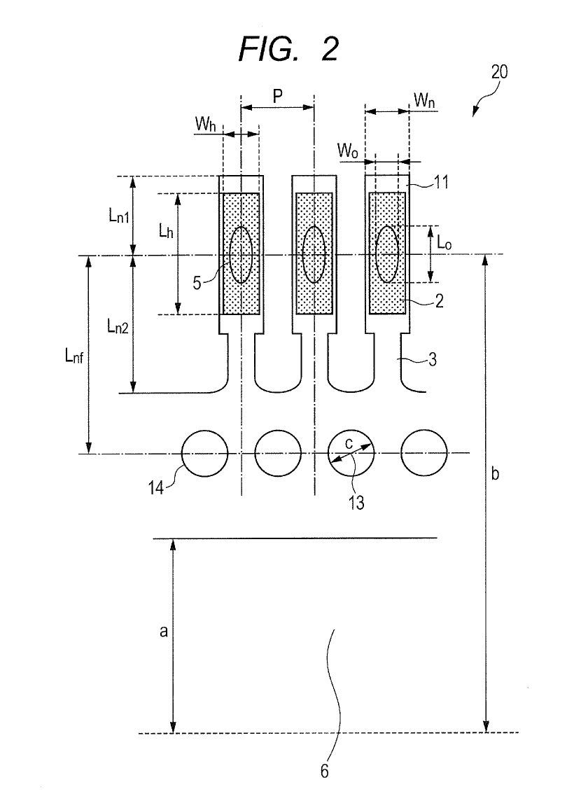

FIG. 1 is a perspective view illustrating an example of a liquid discharge head according to an embodiment of the present invention, which is partially cut out. FIG. 2 is an enlarged plan view illustrating a discharge port portion of the liquid discharge head that discharges a liquid such as ink according to the present embodiment.

A liquid discharge head 20 according to the present embodiment includes: a substrate 1 provided with a plurality of discharge energy generating elements 2 used to discharge the liquid; and a flow channel forming member 4 that is put on and jointed to the main surface of the substrate 1 and defines a plurality of flow channels.

The substrate 1 is made of, for example, glass, ceramics, resin and metal, and is generally made of Si. On the main surface of the substrate 1, the discharge energy generating element 2, an electrode (not illustrated) that applies voltage to the discharge energy generating element 2, and wiring (not illustrated) that is connected to the electrode and has a predetermined wiring pattern are provided for each ink flow channel. On the main surface of the substrate 1, an insulating film (not illustrated) that improves dissipation of accumulated heat is further provided so as to cover the discharge energy generating elements 2.

As illustrated in FIG. 2, the flow channel forming member 4 includes, formed therein: a plurality of discharge ports 5; foam chambers 11 that are respectively communicated with the discharge ports 5 and serve to supply the ink to the discharge ports 5; and a supply port 6 that supplies the ink to the foam chambers 11 via flow channels 3. The discharge port 5 is formed at a position at which the discharge port 5 is opposed to the corresponding discharge energy generating element 2 that is housed in the foam chamber 11 and is placed on the main surface of the substrate 1.

Referring again to FIG. 1, the liquid discharge head 20 includes first and second discharge port lines that are placed parallel to each other so as to sandwich the supply port 6 and are each formed of the plurality of discharge ports 5. At least one of the first and second discharge port lines is formed such that the interval between adjacent discharge ports thereof is 1,200 dpi. At this time, the first and second discharge port lines may be different in the pitch between adjacent discharge ports, as needed for the reason of dot placement.

Such a liquid discharge head as described above includes an ink discharge unit to which ink-jet recording methods disclosed in Japanese Patent Application Laid-Open Nos. H04-10940 and H04-10941 are applied. In some of such liquid discharge heads as described above, air bubbles generated at the time of ink discharge are released to the external air via the discharge ports.

Here, an example of the dimensions of each part in the liquid discharge head according to the present embodiment is described referring to FIG. 2. Note that the following dimensions are given as an example suitable for application of the present invention, but the present invention is not limited thereto.

For example, the arrangement pitch of the discharge ports 5 is P=21 μm, which corresponds to an arrangement of 1,200 dpi. As a result, the width of the foam chamber 11 (the length thereof in the arrangement direction of the discharge ports) is Wₙ=12.8 μm, which is extremely narrow. Further, the discharge amount of the illustrated discharge port 5 is 2.8 ng. The discharge port that discharges such an amount of liquid has an oval shape with a width of Wₒ=8 μm, a length of Lₒ=16 μm, and an aspect ratio of 2.0 (=16/8), in consideration of a balance with dimension restrictions on the discharge port width and the securement of an effective area.

Similarly, the discharge energy generating element 2 has an elongated shape with a width of Wₕ=10 μm, a length of Lₕ=30 μm, and a horizontal-to-vertical ratio of 3.0, in consideration of a balance with dimension restrictions on the discharge port width and the securement of an effective area. Further, the distance from the entrance of the flow channel 3 to the center (center of gravity) of the discharge energy generating element 2 is Lₙ₂=39.6 μm, and the distance from the center (center of gravity) of the discharge energy generating element 2 to the far-side end (the end opposite to the flow channel 3) of the foam chamber 11 is Lₙ₁=22.5 μm. Further, the distance from the center (center of gravity) of the discharge energy generating element 2 to the center of a nozzle filter 14 is L_{nf}=57.0 μm, and the distance from the center of the supply port 6 to an end of the supply port 6 is a=56 μm. Further, the distance from the center of the supply port 6 to the center of the discharge energy generating element 2 is b=137.5 μm, and the diameter of the nozzle filter 14 is c=13 μm. Further, the distance from the center of the discharge energy generating element 2 to the center of the discharge port 5 is 0 μm, that is, the center of the discharge energy generating element 2 and the center of the discharge port 5 are coincident with each other.

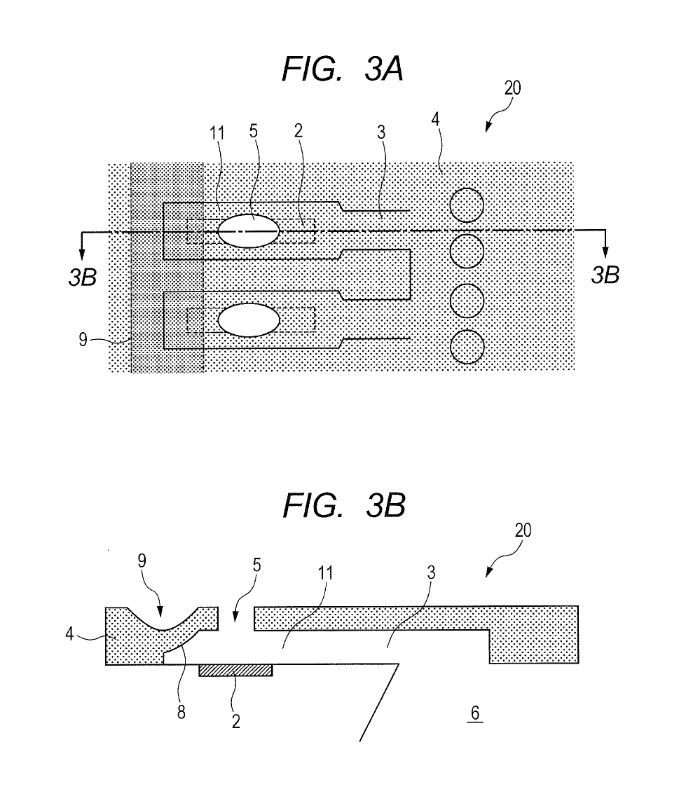

Next, the liquid discharge head according to the present embodiment, particularly, a configuration of the foam chamber is described referring to FIGS. 3A and 3B.

FIG. 3A is a schematic plan view illustrating a configuration of the liquid discharge head according to the present embodiment. FIG. 3B is a schematic sectional view taken along a line 3B-3B in FIG. 3A.

The foam chamber 11 is formed in an elongated shape that extends in the direction (the left-right direction in FIGS. 3A and 3B) orthogonal to the depth direction and the arrangement direction of the discharge ports 5, and has one end that is communicated with the supply port 6 via the flow channel 3. The discharge energy generating element 2 that is placed inside of the foam chamber 11 so as to be opposed to the discharge port 5 also has an elongated shape following the shape of the foam chamber 11.

Further, a concave part 9 is formed on the surface of the flow channel forming member 4 on which the discharge ports are formed, and an inclined surface 8 inclined to the surface of the substrate 1 is formed between: the inner surface of the foam chamber 11 on the discharge port 5 side; and the side wall of the foam chamber 11 on the far side in the supply direction (the far-side inner surface of the foam chamber) so as to follow the shape of the concave part 9. The inclined surface 8 is formed at another end (the end opposite to the supply port 6) of the foam chamber 11, and is inclined toward the discharge energy generating element 2 from the discharge port 5 to the another end of the foam chamber 11. Because the inclined surface 8 thus configured is provided, a portion in which the ink flows less easily can be reduced inside of the foam chamber 11, as described later.

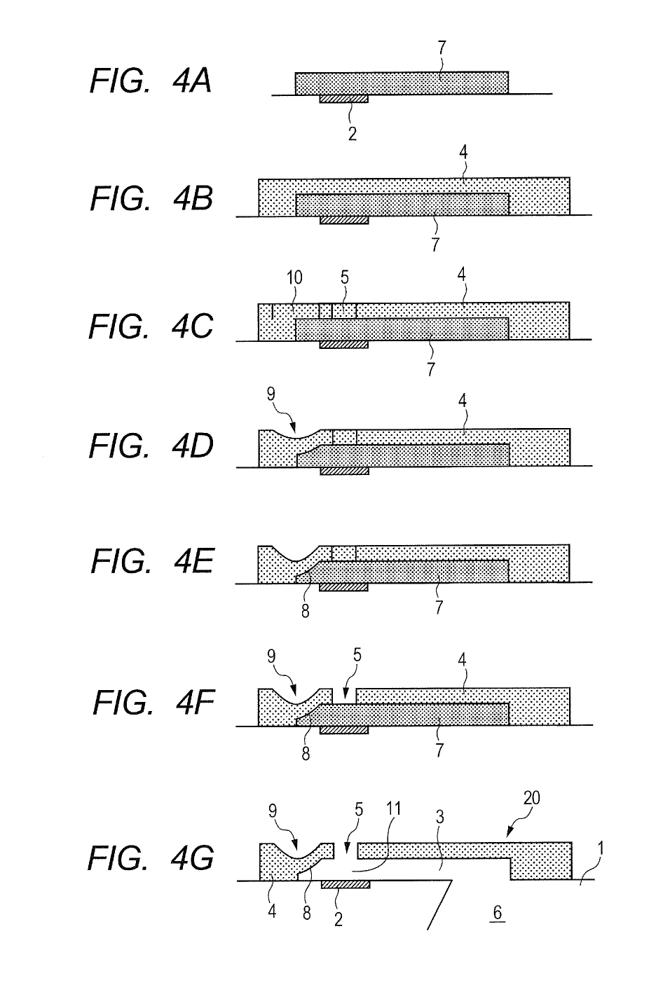

Next, a method of manufacturing the liquid discharge head according to the present embodiment, particularly, a method of forming the foam chamber having the inner surface on which the inclined surface is formed is described referring to FIGS. 4A to 4G.

FIGS. 4A to 4G are schematic sectional views each illustrating a step of manufacturing the liquid discharge head according to the present embodiment, which correspond to FIG. 3B.

First, as illustrated in FIG. 4A, a solid layer 7 to be changed to a mold for the foam chamber 11 and the flow channel 3 is formed on the substrate 1 provided with the discharge energy generating element 2. Next, as illustrated in FIG. 4B, the flow channel forming member 4 is formed on the substrate 1 so as to cover the solid layer 7. The flow channel forming member 4 of the present embodiment is required to have a high mechanical strength and a resistance to ink and be firmly adhered to the substrate. Hence, a negative resist (organic resin), particularly, a cationic polymer substance (epoxy resin) can be used for the flow channel forming member 4. Further, the solid layer 7 of the present embodiment is required not to be dissolved by the negative resist used for the flow channel forming member 4 and is required to enable fine pattern formation and be removable after discharge port formation. Hence, a positive resist (organic resin) can be used for the solid layer 7.

Next, as illustrated in FIG. 4C, a region of the flow channel forming member 4 that excludes portions to be changed to the concave part 9 and the discharge port 5 is exposed to light using a photolithographic technique with the intermediation of a mask (not illustrated). After that, heat treatment (post exposure bake) is performed at a temperature equal to or higher than the softening points of the flow channel forming member 4 and the solid layer 7. Consequently, the region (exposed part) of the flow channel forming member 4 that has been exposed to light goes on curing, so that the resin shrinks. Further, along with the curing and shrinkage of the exposed part of the flow channel forming member 4, the solid layer 7 heated at a temperature equal to or higher than its softening point follows the curing and shrinkage of the exposed part of the flow channel forming member 4 so as not to form any gap. Hence, in a portion (unexposed part) 10 of the flow channel forming member 4 that has not been exposed to light, as illustrated in FIG. 4D, a portion of the solid layer 7 corresponding to the volume that follows such curing and shrinkage forms the concave part 9. Moreover, the unexposed part 10 of the flow channel forming member 4 heated at a temperature equal to or higher than its softening point is recessed according to the space increased by the shrinkage of the exposed part thereof. Consequently, as illustrated in FIG. 4E, a recess is formed also in the solid layer 7 to become the inclined surface 8. Note that the shape and placement of the concave part 9 can be controlled by selecting as appropriate a mask pattern so as to satisfy necessary characteristics of a used liquid discharge head, and the depth of the concave part 9 can be controlled by the amount of exposure to light, the temperature and time of the heat treatment, and the film thickness of the flow channel forming member 4.

Next, a region of the flow channel forming member 4 that includes the concave part 9 (inclined surface 8) and excludes the portion to be changed to the discharge port 5 is exposed to light with the intermediation of a mask (not illustrated). After that, heat treatment is performed again, followed by development, whereby the discharge port 5 is formed as illustrated in FIG. 4F.

Next, a mask (not illustrated) for forming the supply port 6 is appropriately placed on the rear surface (the surface opposite to the surface on which the flow channel forming member 4 and the solid layer 7 are provided) of the substrate 1. Then, the main surface (the surface on which the flow channel forming member 4 and the solid layer 7 are provided) of the substrate 1 is protected by a rubber film (not illustrated), and the substrate 1 made of Si is then subjected to anisotropic etching, whereby the supply port 6 is formed. After the completion of the anisotropic etching, the rubber film on the main surface of the substrate 1 is removed, and the solid layer is dissolved and removed using a solvent. Then, a heating process is carried out for one hour at 200° C. in order to completely cure the flow channel forming member 4. After that, electrical connection and an ink supply unit are provided as appropriate, so that the liquid discharge head 20 illustrated in FIG. 4G is completed.

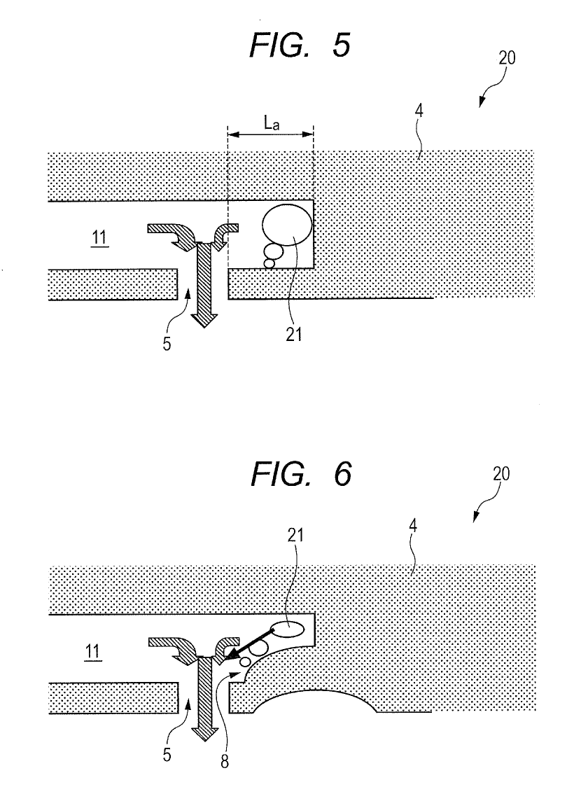

Next, effects of the inclined surface 8 formed on the inner surface of the foam chamber 11 on the discharge port 5 side are described referring to FIG. 5 and FIG. 6.

FIG. 5 is a schematic sectional view illustrating a configuration in the vicinity of the discharge port 5 of a conventional liquid discharge head 120, in which the discharge port 5 faces downward at the time of actual ink discharge.

In the configuration illustrated in FIG. 5, in the case where ink is repeatedly discharged, an air-liquid interface (meniscus) generated at the time of the ink discharge comes into contact with ink that remains in the vicinity of the surface of the discharge port 5 of the flow channel forming member 4. On this occasion, unnecessary fine bubbles, which are different from air bubbles necessary at the time of the ink discharge, may be generated and unfavorably taken into the foam chamber 11.

Such fine bubbles are negligible, if the fine bubbles unite at an early stage with air bubbles that are generated on the discharge energy generating element (not illustrated in FIG. 5) at the time of the ink discharge and are released together to the atmosphere through the discharge port 5 at the time of the ink discharge.

Unfortunately, as described above, in the case where the discharge ports 5 are densely placed at, for example, 1,200 dpi and where the foam chambers 11 having an elongated shape according thereto are adopted, a distance Lₐ from an end of the discharge port 5 to an end of the foam chamber 11 is long. Hence, a flow of ink generated at the time of normal ink discharge is not enough to unite the air bubbles taken in from the meniscus surface with the air bubbles generated on the discharge energy generating element, so that bubbles 21 may accumulate at the end of the foam chamber 11 until the bubbles 21 become large to some extent.

If the bubbles 21 accumulate in a portion of the foam chamber 11 in this way, the efficiency of repetitive foaming on the discharge energy generating element is reduced. Further, the bubbles 21 that accumulate at the end of the foam chamber 11 interfere with the meniscus generated at the time of the ink discharge, so that desired printing performance of the liquid discharge head is more likely not to be achieved. For example, ink discharge may fail unexpectedly, and misdirection may occur at the time of droplet discharge.

FIG. 6 is a schematic sectional view illustrating a configuration in the vicinity of the discharge port 5 of the liquid discharge head 20 according to the present embodiment, in which the inclined surface 8 is formed on the inner surface of the foam chamber 11. Similarly in FIG. 6, the discharge port 5 faces downward.

In the present embodiment, as described above, the inclined surface 8 that is inclined toward the discharge energy generating element (the upper side in FIG. 6) from the discharge port 5 to the far side of the foam chamber 11 (the right side in FIG. 6) is provided on the inner surface of the foam chamber 11 on the discharge port 5 side. With this configuration, the portion in which the ink flows less easily, that is, the portion in which the unnecessary air bubbles 21 taken into the foam chamber 11 accumulate can be reduced inside of the foam chamber 11 as far as possible. As a result, even in the case where fine air bubbles are deposited to become a large air bubble, the large air bubble can be united at an early stage with the air bubbles generated on the discharge energy generating element, and can be released together to the atmosphere through the discharge port 5 at the time of the ink discharge, before the large air bubble significantly affects the ink discharge. Hence, an influence on the printing performance can be reduced. In order to suppress the accumulation of air bubbles, the inclined surface can be formed of a curved surface that is convex toward the inside of the foam chamber 11 as illustrated in FIG. 6. Not limited thereto, the inclined surface may be formed of a plan surface.

Next, the liquid discharge head according to the present invention is described in detail by way of some examples. Note that the present invention is not limited to the following examples, may be implemented as a combination of the following examples, and may be changed as appropriate within a range within which the gist of the present invention is not changed.

### Example 1

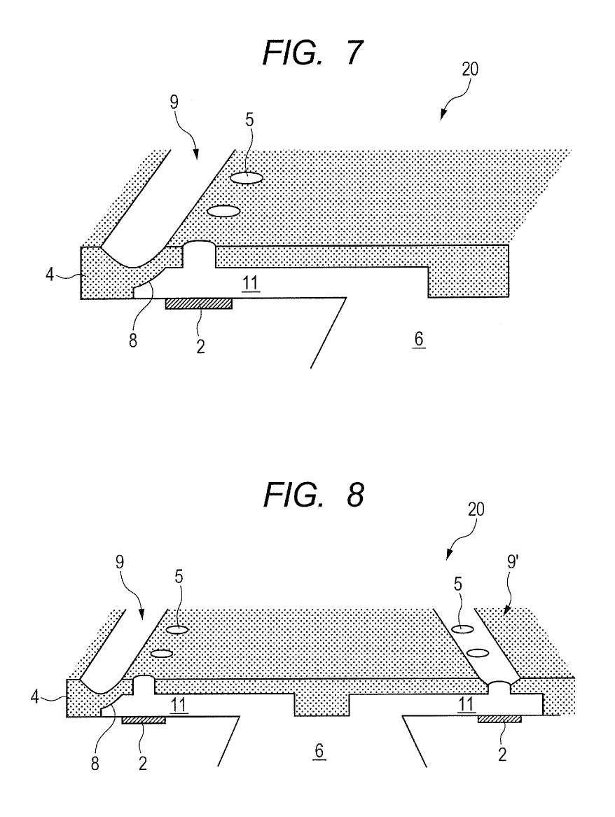

FIG. 7 is a schematic view illustrating the liquid discharge head 20 manufactured according to the present example.

In the present example, the liquid discharge head illustrated in FIG. 7 was manufactured based on the above-mentioned embodiment. Specifically, the discharge ports 5, that is, the discharge energy generating elements were arranged in line at 1,200 dpi such that the respective centers of the discharge energy generating elements 2 were linearly aligned along the arrangement direction thereof. Then, the flow channel 3, the foam chamber 11 and the discharge port 5 were formed for each discharge energy generating element 2. Note that, although not illustrated in FIG. 7, a similar configuration was provided also on the opposite side of the supply port 6.

Further, the concave part 9 for forming the inclined surface 8 on the inner surface of the foam chamber 11 was formed in a rectangular belt-like shape along the arrangement direction of the foam chambers 11 arranged at a pitch of about 1,200 dpi, and the concave part 9 was collectively formed so as to extend along at least two discharge ports 5. If the concave part 9 is collectively formed in this way, the inclined surface 8 can be formed substantially uniformly between adjacent foam chambers 11.

Recording and printing were performed using the liquid discharge head 20 manufactured according to the present example. As a result, bubbles that remain in the flow channels were reduced, an unexpected failure in ink discharge and misdirection at the time of droplet discharge, which have randomly occurred in conventional cases, were less frequent, and excellent printing was achieved.

### Example 2

FIG. 8 is a schematic view illustrating the liquid discharge head 20 manufactured according to the present example.

In the liquid discharge head 20 according to the present example, the same concave part 9 as that in Example 1 was formed for part of the plurality of discharge energy generating elements 2, and the present example was different from Example 1 in another feature. Specifically, for one (the left group in FIG. 8) of two groups of the discharge energy generating elements 2 placed parallel to the supply port 6, the concave part 9 was manufactured similarly to Example 1. On the other hand, for the other (the right group in FIG. 8) of the two groups, another concave part 9′ was formed on at least one discharge port 5 at the same time of forming the concave part 9 for forming the inclined surface 8.

Such a configuration has an advantage that, in the case where the plurality of concave parts 9 and 9′ is provided for different purposes, the concave part 9 for forming the inclined surface 8 and the concave part 9′ formed on the discharge port(s) 5 can be formed so as not to interfere with each other. Note that, in the case where there is space enough to form both the concave parts 9 and 9′ for one discharge energy generating element 2 (that is, one discharge port 5), both the concave parts 9 and 9′ may be formed. In this way, the present invention does not require providing the inclined surface for all the discharge ports formed above the substrate 1, and it is possible to omit forming the inclined surface for a discharge port having a small influence of bubble accumulation due to difference in the shape of a foam chamber and the discharge amount.

Recording and printing were performed using the liquid discharge head 20 manufactured according to the present example. As a result, bubbles that remain in the flow channels were reduced, an unexpected failure in ink discharge and misdirection at the time of droplet discharge, which have randomly occurred in conventional cases, were less frequent, and excellent printing was achieved.

### Example 3

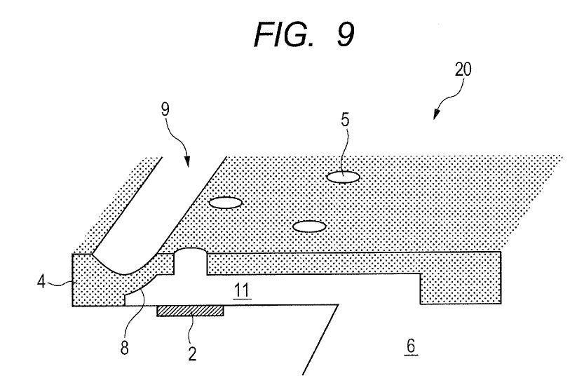

FIG. 9 is a schematic view illustrating the liquid discharge head 20 manufactured according to the present example.

In the present example, for at least one of two groups of the discharge energy generating elements 2 placed parallel to the supply port 6, the respective centers of the discharge energy generating elements 2 were placed in a zigzag pattern.

Moreover, the concave part 9 was formed such that the inclined surface 8 was provided only for the foam chambers 11 respectively corresponding to the discharge energy generating elements 2 whose distance from the supply port 6 was longer, among the discharge energy generating elements 2 placed in the zigzag pattern. This is because, among the discharge energy generating elements 2 placed in the zigzag pattern, the discharge energy generating elements 2 whose distance from the supply port 6 is longer have a horizontal-to-vertical ratio higher than that of the discharge energy generating elements 2 whose distance therefrom is shorter, in many cases. That is, as the distance from the supply port 6 is longer, the distance between the discharge port 5 and the far-side wall of the foam chamber 11 is longer, and hence the necessity of the inclined surface 8 is higher. In this way, in the case where the shape of one of the discharge energy generating elements 2 and the foam chambers 11 is different, the inclined surface can be provided for at least the discharge ports on a higher horizontal-to-vertical ratio side.

Recording and printing were performed using the liquid discharge head 20 manufactured according to the present example. As a result, bubbles that remain in the flow channels were reduced, an unexpected failure in ink discharge and misdirection at the time of droplet discharge, which have randomly occurred in conventional cases, were less frequent, and excellent printing was achieved.

### Example 4

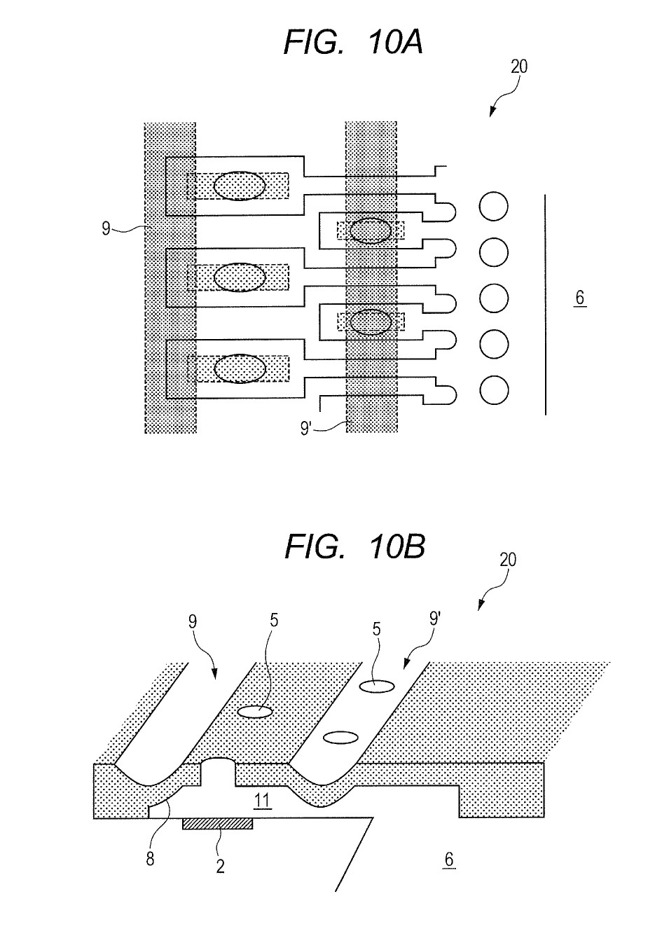

FIG. 10A and FIG. 10B are schematic views each illustrating the liquid discharge head 20 manufactured according to the present example. FIG. 10A is a plan view, and FIG. 10B is a sectional perspective view.

In the present example, in addition to the configuration of Example 3, the same concave part 9′ as that in Example 2 was formed for at least one discharge port 5 around which the concave part 9 for forming the inclined surface 8 was not formed, at the same time of forming the concave part 9 for forming the inclined surface 8. That is, the concave part 9′ was formed on the discharge port(s) 5 for the discharge energy generating element(s) 2 whose distance from the supply port 6 was shorter, among the discharge energy generating elements 2 placed in the zigzag pattern. With this configuration, the concave part 9 for forming the inclined surface 8 and the concave part 9′ formed on the discharge port(s) 5 can be less likely to interfere with each other. Note that the concave part 9′ forms a convex part that protrudes inside of the flow channel(s) 3 corresponding to the discharge energy generating element(s) 2 whose distance from the supply port 6 is longer.

Recording and printing were performed using the liquid discharge head 20 manufactured according to the present example. As a result, bubbles that remain in the flow channels were reduced, an unexpected failure in ink discharge and misdirection at the time of droplet discharge, which have randomly occurred in conventional cases, were less frequent, and excellent printing was achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-103319, filed Apr. 27, 2012, which is hereby incorporated by reference herein in its entirety.

What is claimed is:

1. A liquid discharge head comprising:
a discharge port that serves to discharge a liquid;
a discharge energy generating element that generates energy used to discharge the liquid;
a foam chamber that houses the discharge energy generating element and is communicated with the discharge port; and
a flow channel that is communicated with the foam chamber and serves to supply the liquid to the foam chamber,
wherein an inclined surface is formed between: a side wall of the foam chamber on a side opposite to the flow channel; and a surface of the foam chamber on which the discharge port is formed, and
the inclined surface is inclined to a plane on which the discharge energy generating element is formed.

2. The liquid discharge head according to claim 1, wherein the inclined surface is a curved surface that protrudes toward an inside of the foam chamber.

3. The liquid discharge head according to claim 1,
wherein the discharge energy generating element is provided on a substrate,
the flow channel is defined by a flow channel forming member in which the discharge port is formed, and
the substrate and the flow channel forming member are jointed to each other.

4. The liquid discharge head according to claim 3, wherein a concave part is formed along the discharge port on one surface of the flow channel forming member, the one surface being opposite to another surface thereof jointed to the substrate.

5. The liquid discharge head according to claim 4, wherein the concave part is formed at a position corresponding to a position at which the inclined surface is formed in the flow channel forming member.

6. A liquid discharge head comprising:
a discharge port that serves to discharge a liquid;
a foam chamber that is communicated with the discharge port and serves to supply the liquid to the discharge port; and
a discharge energy generating element that is placed inside of the foam chamber so as to be opposed to the discharge port and generates energy that enables the discharge port to discharge the liquid,
wherein the foam chamber and the discharge energy generating element are each formed in an elongated shape that extends in a direction orthogonal to a depth direction of the discharge port,
the foam chamber has one end communicated with a supply port that supplies the liquid to the foam chamber,
an inclined surface is formed on an inner surface of the foam chamber on the discharge port side, and
the inclined surface is inclined toward the discharge energy generating element from the discharge port to another end of the foam chamber.

7. The liquid discharge head according to claim 6, wherein a concave part is formed at a position corresponding to the inclined surface, on a surface of a flow channel forming member that defines the foam chamber.

8. The liquid discharge head according to claim 7, wherein another concave part different from the concave part is formed in the flow channel forming member.

9. The liquid discharge head according to claim 8, wherein the another concave part is formed at a position corresponding to a flow channel defined by the flow channel forming member so as to form a convex part that protrudes inside of the flow channel that communicates the foam chamber with the supply port.

10. The liquid discharge head according to claim 6, wherein a plurality of the discharge ports is arranged at a pitch of 1,200 dpi or more.

11. A method of manufacturing a liquid discharge head, for manufacturing the liquid discharge head according to claim 6, the method comprising:
forming a solid layer to be changed to a mold for the foam chamber, on a substrate;
forming a flow channel forming member on the substrate so as to cover the solid layer;
exposing a region of the flow channel forming member to light, followed by heat treatment, the region excluding portions corresponding to the discharge port and the inclined surface of the foam chamber;
exposing a region of the flow channel forming member to light, followed by heat treatment and then development, the region excluding the portion corresponding to the discharge port; and
removing the solid layer.

12. The method of manufacturing a liquid discharge head according to claim 11, wherein, in the exposing a region of the flow channel forming member to light, followed by heat treatment, the region excluding portions corresponding to the discharge port and the inclined surface of the foam chamber, a temperature of the heat treatment is equal to or higher than a softening point of the solid layer.

13. The method of manufacturing a liquid discharge head according to claim 11,
wherein the flow channel forming member is formed of a negative organic resin, and
the solid layer is formed of a positive organic resin.
